(19) United States
(12) Patent Application Publication
(10) Pub. No.: US 2019/0074792 A1
(43) Pub. Date: Mar. 7, 2019

(54) SOLAR ENERGY ROOF TILE HAVING A LENGTH-VARIABLE CONNECTING ELEMENT

(71) Applicant: RheinEnergie AG, Köln (DE)

(72) Inventor: Peter HAKENBERG, Solingen (DE)

(73) Assignee: RheinEnergie AG, Köln (DE)

(21) Appl. No.: 16/093,659

(22) PCT Filed: Jan. 30, 2017
(86) PCT No.: PCT/EP2017/051898

§ 371 Date: Oct. 15, 2018

(30) Foreign Application Priority Data
Apr. 15, 2016 (DE) 10 2016 107 016.5

(51) Int. Cl. H02S 20/25; F24S 20/69; F24S 80/30; H02S 40/36; H02S 40/44

(52) U.S. Cl. CPC H02S 20/25; F24S 20/69; F24S 2025/6004; H02S 40/36; H02S 40/44; F24S 80/30

(57) ABSTRACT

The invention relates to a solar energy roof tile (20) for the production of electrical and thermal energy from solar radiation. The shape thereof essentially corresponds to the shape of a conventional roof tile, having a base tile (22), for mounting the solar energy roof tile (20) onto a rooftop and furthermore comprising a photovoltaic module (90) arranged on top, which is connected to a first power line (96) and a second n power line 98), and an absorber (26) with an inlet line (34) and an outlet line (36) passed-through by a medium, wherein the inlet line (34), at its free end, comprises a first connecting element (38), the outlet line (36), at its free end, comprises a second connecting element (40), at least one of which lines (34, 36) are designed as being changeable in length in a base state, both connecting elements (38, 40) are arranged within the outer dimensions of the solar energy roof tile (20), at least one of the two connecting elements (38, 40) being expandable beyond the outer dimensions of the solar energy roof tile (20) in an assembly state and being connectable to a corresponding connecting element (38, 40) of an adjacent solar energy roof tile (20) while in medium communication and electrically conductive, the length-variable line (34, 36) comprises one of the two power lines (96, 98).

The present invention relates to a solar energy roof tile to produce electrical and thermal energy from solar energy, wherein the solar energy roof tile essentially has the shape of conventional roof tiles.

Solar-thermic, especially the provision of hot water, is the most widespread technique for utilization of solar radiation, wherein solar collectors are used to heat fluids. The solar radiation meanwhile enters an absorber surface of the collector to heat it. The generated heat will be transferred to a flow-through medium, generally a fluid or even air. The medium heated by the solar radiation is usually passed to a hot water storage tank by a circulating pump, wherein the generated heat is transferred from the heated medium (e.g. a carrier fluid) to the industrial water or drinking water in the hot water storage tank via a heat exchanger. In doing so, the medium cools down and will subsequently be recycled back to the collector.

If a fluid is used as a medium, a mixed antifreeze liquid and water is especially suitable. Alternatively, heating-circuit water itself may be pumped into the collector and may be heated therein. Even in this case, drinking water may be heated via the heat exchanger.

Photovoltaics is also a widespread technique for the utilization of the solar radiation. The solar radiation enters a photovoltaic module with solar cells. Said solar cells convert the energy of the sunlight into electrically usable energy. The conversion von solar energy into electrically usable energy is well known and will not be described in further details.

Utilization of roof surfaces for affixing solar collectors is well-suited. Commercially available solar collectors are mostly applied to already completed roofs in addition. Fastening elements are often required to be mounted through the roofing sheet onto the roof supporting structure, wherein fastening is required to be stormproof and is preferably also required to be corrosion-protected. When perforating the conventional roofing sheet, sealing and subsequent tightness problems inevitably will arise. In Addition, increase of the roof load occurs, often resulting in a necessary reinforcement in the roof trusses. Moreover, such solar collectors negatively interfere with the optical appearance of the roof.

Alternatively, solar thermal or photovoltaic roof tiles are known, which are used instead of the generally used roof tiles, roof tiles or roofing stone articles. Solar energy roof tiles also comprise an absorber for receiving the solar energy and are passed through by a medium, preferably a fluid, which becomes heated accordingly. Photovoltaic roof tiles, at the top, i.e. facing the sun, include photovoltaic modules or solar cells for the reception and conversion of the solar energy. In this way, the above-mentioned disadvantages of the assembled solar collectors will largely be avoided, but installation of such solar roof tiles is laborious, and is relatively difficult, compared to conventional roof covering with commercially available roof tiles. An essential problem especially is the great installation effort for establishing the fluid communication of individual solar thermal roof tiles. The through-passing medium is required to be passed from one solar thermal roof tile to the next one, requiring suitably tight connection. Thus, expenditure in time and assembly work is significantly higher. Similarly, for electrical connection of photovoltaic roof tiles, due to the connection procedures, expenditure in assembly work and time is significantly higher than with large-area solar collectors.

Such roof tiles for the utilization of solar energy and the assembly thereof are for example described in DE 10 2011 055 904 A1 and in DE 20 2013 002 407 U1. Assembly of the roof tiles as described therein is complex and difficult, especially as additional components are required and modifications to the supporting structure become necessary.

The object of the present invention is to provide a solar energy roof tile the production, assembly and maintenance of which is as simple and inexpensive as possible. In this context, it is essential for the mounting procedure to differ as little as possible from a roof covering procedure with usual roof tiles. The overall system for energy conversion, which makes use of the solar energy roof tiles according to the invention is then expected to operate in a permanent and reliable manner.

The object will be solved by a solar energy roof tile having the features of the Claim 1 as well as the independent Process Claim. Thus, a solar energy roof tile according to the invention comprises an absorber arranged on the top side and being passed through by a medium, having an inlet line and an outlet line, the absorber being arranged on a base tile. The base tile is for fixing the solar thermal roof tile on a roof. Moreover, a photovoltaic module is provided, which also is arranged on top, i.e. facing the sun.

The shape of the solar energy roof tile according to the invention essentially corresponds to a conventional roof tile, so that the appearance of a roof or a house, respectively, will hardly be changed by the use of the solar energy roof tile. Herein, the meaning roof tile is to be understood as being synonymous to roof covering elements such as roof tiles, roofing stones or roofing shingles, and is not meant to limit the invention to roof tiles.

The absorber for the production of thermal energy comprises an inlet line and an outlet line, the photovoltaic module comprises a first power line and a second power line, respectively. Both the absorber and the photovoltaic module are connectable to adjacent solar energy roof tiles via their lines.

In the following, it is to be considered that a fluid serves as a medium, wherein a gaseous medium, for example air, may also be conceivable. The inlet line, at its free end, has a first connecting element, and the outlet line, at its free end, has a second connecting element, which are connectable to each other in fluid-medium communication. What is essential is that one of the lines are formed as having length variation. In this way, in a first initial state both connecting elements may be arranged within external dimensions of the solar energy roof tile, in the assembly state, the connecting element may be expanded due to its length-changeable line so that it projects beyond the external dimensions of the solar energy roof tile. In this context, the meaning external dimensions or overall dimensions relates to the overall dimensions of the solar energy roof tile in planar or horizontal extension, respectively, which in a common rectangular solar energy roof tile are determined by the two longitudinal sides and the two transverse sides. In this context, the meanings horizontal and vertical relate to a solar energy roof tile abutting against a horizontal plane, so that the main extension thereof is in the horizontal plane. This means that the solar energy roof tile according to the invention, in its initial state, has the same dimensions as a commercially available roof tile without utilization of solar thermics. In the assembly state, however, the second connecting element may be expanded beyond the external dimensions of the solar energy roof tile and may be connected to a first connecting element of an adjacent solar energy roof tile. Both of the connected solar energy roof tiles may subsequently be moved towards each other, wherein the outlet line contracts again, until the two solar energy roof tiles, in some areas, are arranged one over the other such that the two connecting elements are arranged below the upper solar thermal roof tile, i.e. they are arranged as being no more visible.

Basically, according to the invention, the inlet line or the outlet line or even both lines may be formed as being changeable in length, in an especially advantageous embodiment, according to the invention, the outlet line is formed as being changeable in length. In the following, the invention will therefore be exemplified for that embodiment, but which is only one of the various possibilities.

The second connecting element connected with the outlet line is preferably guided in a longitudinal groove extending in an extension direction in the base tile. On the other hand, the inlet line and the first connecting element are fixedly arranged within the external dimensions of the solar energy roof tile. The inlet line, which is changeable in length, significantly facilitates assembly on the roof, as the distance deviations between adjacent solar energy roof tiles during roofing may quickly and simply be compensated. The variable overlapping of the roof tiles results from different roof batten clearances, which in turn arise due to integer number of roof tiles, when varying roof lengths (from the gutter board to the crest) will be realized.

The meaning of inlet line changeable in length is to be understood such that said inlet line varies in its length in relation to the extension direction of the second connecting element. In an especially preferred embodiment, the outlet line may hence be formed as a so-called trumpet tube, where two tube portions of different diameter that are sealed against each other may slide into each other. Alternatively, an outlet line may also be used, the absolute length of which remains constant, but enables increase in length in extension direction due to the change in geometric set-up. This, for example, applies to a helically wound elastic outlet line, which, according to the invention, may also be used. Finally, operation of the invention is essential, in that the outlet line allows for the second connecting elements to be pulled out.

In an especially advantageous embodiment the two connecting elements are formed as a snap-in connection or as an engaging connection. For example, the first connecting element may comprise an accommodation opening, into which the second connecting element is insertable and is releasably maintained in a form-fitting manner. Form-fitting, in this context, may be effected by undercutting in the accommodation opening, at which undercut a retaining edge of the second connecting element abuts.

To effect safe but still releasable connection, elastic engaging means may be provided, which engage into the respective retaining region. In a particularly easy embodiment, the second connecting element may comprise openings or recesses, into which elastic and/or spring-loaded pins of the first connecting element engage. During connection procedure, the pins are initially displaced by the second connecting element until they may return into the respective recesses or openings.

The two connecting elements are fixedly connected in the engaged state, wherein the connection especially is effected by at least one, preferably two spring-loaded pins. In this context, the engaging openings and the free end of the pin are dimensioned such that the pin is only partially and not completely inserted into the opening. For this purpose, the pin, at its free end, may be formed conically. It will thereby be achieved that the connection in vertical direction, i.e. transversally to the insertion direction of the pin, is locked, on the other hand, the spring force acting in longitudinal direction of the pin compressed the two connecting elements towards each other, thereby assuring a tight connection. It is to be understood that other engaging connections may also be utilized, which ensure sufficiently reliable connection of the two connecting elements. It thereby is essential that the connection for the fluid passing through is tight.

Advantageously, the connection may be released (with the help of an appropriately formed tool) by compressing the pins opposite to the spring force and the second connecting element will be pulled out of the first connecting element. For this purpose, for example an appropriate tool may be used, which disengages the pin and the engaging opening.

A rotary slide (rotatable disc with recesses) may be an alternative solution of the connection, sein, the rotary slide, in the assembled state of two roof tiles, being arranged in front of the two connecting elements in the direction of the roof tile located higher on the rooftop. In this embodiment variant it is possible for the second connecting element to be axially removed out of the first connecting element. Thus, separation of the two connecting elements is not done by removal towards the top, but by axial removal. The rotary slide is operated via a shaft at the front end of the roof tile by means of a tool, for example a hexagon-assembly tool for screws and nuts. The rotary slide blocks the axial movement of the first connecting element only in the “closed” position, it is exclusively in this position that the second connecting element may be engaged and maintained in the first connecting element, as described above. In the “open” position, the rotary slide is turned into a position, where a recess in the surface of the rotary slide exposes an opening, through which the second connecting element may be removed out of the first connecting element.

Advantageously, the rotary slide replaces retaining collars, via which the roof tile would otherwise be engaged into a roof batten. The retaining collars, in the mounted state, engage behind the roof batten. In this embodiment, this function is now performed by the rotary slide.

In order for the roof tile itself and not only the connecting element to be exposed, the rotary slide preferably has another recess for the roof batten. Thus, the rotary slide, in the “closed” state, maintains the roof tile at the roof batten. The rotary slide is arranged centrally at the upper edge of the roof batten (in the mounted state), in relation to the width of the roof tile. In order for the roof tile to be able to be removed, e.g. for repair, the rotary slide is only required to be turned into the “open” position, so that it does no longer engages behind the roof batten. Basically, the holding portion of the rotary slide acting as retaining collars will be turned away. The second connecting element as well as the roof tile holder will be released and the roof tile may be pulled out of the tile-covered roof surface towards the front.

When mounting another roof tile for replacing the removed one, the rotary slide will first be turned into a “semi-closed” position. In this position, the recess for the second connecting element is no longer located in front thereof. Thus, the second connecting element may be joint and engaged into the first one. The roof tile has to be placed in front of the gap in the roof surface to be able to contact the connecting elements. The rotary slide prevents axial displacement of the second connecting element but does not protrude over the roof tile in the direction of the roof or of the roof batten, respectively. In this way, the roof tile may be inserted into the roof surface for the remaining distance and the rotary slide may subsequently be turned into the “closed” position. Consequently, the recess for the roof batten will be turned away, the rotary slide engages behind the roof batten and thus maintaining the roof tile in place. An especially advantageous embodiment of the connection of the first and second connecting element is a sledge, which sledge slides the inlet line and the current contacts into the second connecting element in the moment, when the first and second connecting elements will be inserted into their connection position. Thus, the electrical leads also extend through the sledge. Das second connecting element, in its final connection position, pushes a lever downwards, which releases the sledge, so that it then inserts the outlet lines and the current contacts by means of spring force. The second connecting element will be pushed by some millimeters, preferably about 4 mm to abut the rotary slide, the rotary slide, at an undercut, locking upwardly with its front edge.

When replacing the solar roof tile (e.g. in case of damage), this sledge, following removal of the solar roof tile, will be re-biased by being pushed back into its initial position and will re-engage with the lever.

The solar energy roof tile preferably is built up in a sandwich-type manner, wherein, between the base tile, which comprises the elements for mounting on a roof supporting structure, and a transparent covering element the absorber with the respective connecting elements, as well as the photovoltaic module is arranged.

The absorber may consist of an upper non-medium-containing absorber element and a lower medium-containing absorber element. The upper absorber element is designed such that it heats-up to the maximum, especially by way of dark or black coloring, respectively. It is preferred, that the two absorber elements are fabricated of metal and are soldered or welded to each other. In order to keep the manufacture especially easy and cost-effective, the roll-welding process has been proven as a preferred connecting process. Both the upper absorber element itself and the base tile may be produced by a deep drawing process. A circumferential frame element arranged between the base tile and the absorber or the covering element, respectively, is, on the one hand, for fixing the individual elements to each other, and on the other hand, the tightness of the solar energy roof tile will be increased.

In order to additional facilitate assembly, the second connecting element is preferably guided at the absorber or the base tile. The guide may for example be effected by a longitudinal groove in the base tile, into which the retention region of the second connecting element protrudes and is retained. It is thereby assured that the second connecting element may exclusively displace along the longitudinal groove and especially may not get distorted.

In an especially advantageous embodiment, the accommodation opening is formed within the first connecting element in a T-shaped manner and is formed as being open towards the top. Accordingly, the second connection element is also formed in a t-shaped manner and is insertable into the accommodation opening from the top. By way of the T-shape, locking in the essentially horizontal pulling direction is automatically created. For the connection in the vertical direction may not be released, spring-loaded pins, which are arranged in the first connection element, engage into openings of the second connecting element, which are preferably arranged in the two short regions of the T-shape that are formed transversally to the longitudinal extension of the second power line.

Thus, the solar energy roof tiles according to the invention may be installed fast and easy onto a roof supporting structure. They may be conveyed, with the second connection element being retreated, like commercially available roof tiles onto the roof and may be processed thereon. For this, it is only required for the second connection element to be pulled out of the solar energy roof tile and to couple it, via the engaging connection, to an adjacent first connection element.

A first power line preferably extends from the cable connections of the photovoltaic module along the outlet lines to the second connecting element and is for example attached to the outside thereof or helically surrounds it. In an especially advantageous embodiment variant, it may as well be integrated in the outlet line, for example to extend in the interior of the outlet line. In this case, the power line must be suitable for being installed in a fluid. Alternatively, it may be provided for the outlet line to comprise a cavity, preferably a longitudinal channel in its wall, in which the power line extends. In this way, the power line does not come into contact with the fluid within the outlet line. Finally, in an especially advantageous embodiment variant, the outlet line itself is fabricated of electrically conductive material, at least in certain areas. For example, areas of the outlet line may be fabricated of electrically conductive material, which areas cannot come into contact with the fluid.

According to the invention, the electrical connection of the connecting elements is done by contact surfaces, which are arranged at the respective connecting elements. Said connecting elements, in the assembled state of the connecting elements, contact each other so that the electrical power may be conducted. Alternatively, contact surfaces may as well be arranged at another location of the solar energy roof tile, i.e. it may be provided independently of the connecting elements.

Preferably, the accommodation and the snap-in element, at least in certain areas, may be formed of electrically conductive material, and may form the contact surfaces for conducting electrical power. Especially, the pins per se and an edge of the accommodation, which contact the pins in the assembled state, may form the contact surfaces.

An overall system for utilization of thermal energy comprises the above-described solar thermal roof tiles, wherein, in addition, a manifold, preferably below the so-called ridge-tile row, and a supply line, which preferably replaces the so called gutter board, are provided. For this, the uppermost row of solar energy roof tiles adjacent to the ridge-tile row will be connected via a collecting supply line, which especially may be formed elastically, to the collecting line. The collecting supply line may also be formed as being changeable in length, but very often, a relative supple and flexible tubing will also be sufficient. It replaces the outlet line, i.e. it is not connected to the absorber, but has a free end, which may be inserted into the collecting line.

The solar energy roof tiles adjacent to the gutter board have supply feeding lines instead of inlet lines. The supply feeding line may also be formed as being changeable in length, but here also a flexible tubing will very often be sufficient. The supply feeding line is connected to the first connecting element, but has no connection towards the absorber, but, with its free end, is rather connectable to the feeding line. The collecting line and the feeding line are each connected to the heating system in the house, preferably the heat exchanger. Appropriate connecting lines, a cold-water line towards the feeding line and a hot water line towards the collecting line may be installed inside or outside of the house. Installation within a downspout that is arranged within a house has been proven to be especially advantageous. Said downspout is for discharging rainwater, but on the other hand, the connecting lines may be accommodated in the interior thereof. In an especially preferred embodiment, said connecting lines may be separated by a separating wall from a rainwater-conducting region of the downspout. Thus, for this purpose, the downspout is divided into two compartments.

In addition, a main power line is provided, which connects the photovoltaic modules with a power infeed site in the house. Said main power line may as well extend through the downspout.

Moreover, it has been proven to be of advantage, if a pilot current may be fed via the connecting elements, besides the electrical line for the recovered energy. Said pilot current is especially required for so called CAN busses.

An essential advantage of the invention results in that the absorber or the fluid passed through the solar energy roof tile may be utilized for cooling the photovoltaic module, respectively. In this way, effectivity of the photovoltaic module is significantly increased, and the released heat may additionally be utilized by the solar thermal system. It is therefore provided, to arrange the absorber and/or the inlet and outlet lines within the solar energy roof tile, such that optimal heat transfer from the photovoltaic module to the absorber and/or to the inlet and outlet lines is assured. Different elements may either directly contact each other or connecting elements of materials are used, which have high heat conductivity. An essential advantage of the described connection configuration with the connecting elements according to the invention, are the degrees of freedom of the connection in translational and rotational direction. This, for example, may additionally be assisted by a rubber bearing of the two connecting elements.

The solar roof tile of the invention is especially suitable for use with a wind suction protection which is also new and advantageous. In some geographic regions, wind suction protections have already become mandatory. Prevention of unroofing the roof due to storm (wind suction) is therewith intended. This will typically be realized by attaching a wire or a clamp to the der roof tile, which anchors the roof tile in the roof batten. The anchoring procedure is comparatively time-consuming, and depending on the on-site situation, sometimes requiring more time than the roofing procedure with the roof tile. Moreover, it is extremely difficult to replace such a roof tile (e.g. if it is damaged) in the roof network structure (completely tiled roof).

The wind suction protection of the invention diminishes those problems. A snap-in lug is activated when overlaying the roof tile onto the roof tile, it will be urged behind the roof tile by spring force and thus clasping behind. For disengaging this connection mechanism, if repair is required, a return mechanism having a draw bar including draw bar eye is advantageously provided at the bottom side of the roof tile in the front region. When slightly lifting the roof tile in the front, it is possible for a hook to engage into the draw bar eye and pulling the snap-in lug back to its engaging position. This engaging position is the delivery default state and will be changed during roofing procedure, i.e. when the roof tile will be laid onto the roof batten in proper position. Replacing a conventional roof tile has always been relatively difficult (even without additional wind suction protection). This is due to the fact that the roof tile to be replaced is required to be removed from the roof batten, even though two adjacent roof tiles are loaded thereon (on top and usually on the left-hand side thereof). However, if another two connections are required to be released, this is almost impossible, unless additional auxiliary tool will be used. The wind suction protection with snap-in lug solves the problem by providing an additional mechanism for lifting the roof tile. For this, a draw bar including draw bar eye is drawn under the roof tile at the front end, which in turn actuates a draw key between the roof tile and the roof batten to lift the roof tile. Another improvement or alternative according to invention, respectively, is to actuate another draw bar with drawbar eye at the front end of the roof tile, to release the connection between the roof tiles by actuating an ejector (to eject a pater from a mater). In this way, a lifting tool becomes unnecessary.

Said three draw bar eyes are all located below the roof tile at the lower end. The draw bar eyes are vertically oriented and would “spring-off” from the bottom side of the roof tile as soon the latter will be lifted in the front. An eye is then advantageously arranged slightly offset from the center of the roof tile (center of the front side) and releases the connection. This position is advantageous as the connection is arranged as being exactly located in the center of the roof tile. Some centimeters offset thereof, for example about 3 cm to the left, according to the invention, the draw bar eye for the snap-in lug of the wind suction protection is positioned. This position is advantageous as the typical wind suction protection is always provided at the left roof tile side. On the other side, some centimeters to the right of the center, preferably also 3 cm to the right of the center, the draw bar eye for the draw key is preferably arranged, which is for lifting the roof tile.

According to the invention, combination of the draw bar eyes for the snap-in lug and the roof tile lifter is conceivable. The sequence would be such that in the first half of the draw path, the snap-in trap will be retracted, and in the second half of the drawing distance, the draw key for lifting the tile will be actuated. It is preferred that a spring element is provided, via which the bias applied to the snap-in lug will be maintained, for said snap-in lug does not snap back when lifting.

Alternatively, wind suction protection may also be done by a bolt along and across the roof tile, which is transversally screwed into the lower third of the roof batten. The bolt is approximately arranged in the center of the roof tile. When using a rotary slide, it is positioned exactly opposite to the rotary slide. Rotation of the bolt is done at front side of the roof tile. For the rotary slide, it is arranged at the lower left-hand side of the central elevation of the der roof tile, and the bolt for the wind suction protection is arranged at the lower right-hand side thereof. This has the advantage that they optically hardly attract attention, considering the fact that they are formed as having a black surface (matching the roof tile appearance).

The invention will be explained in detail by way of the following figures, said figures showing a preferred working example of the invention, which, however, is not intended to limit the invention to the features shown, wherein

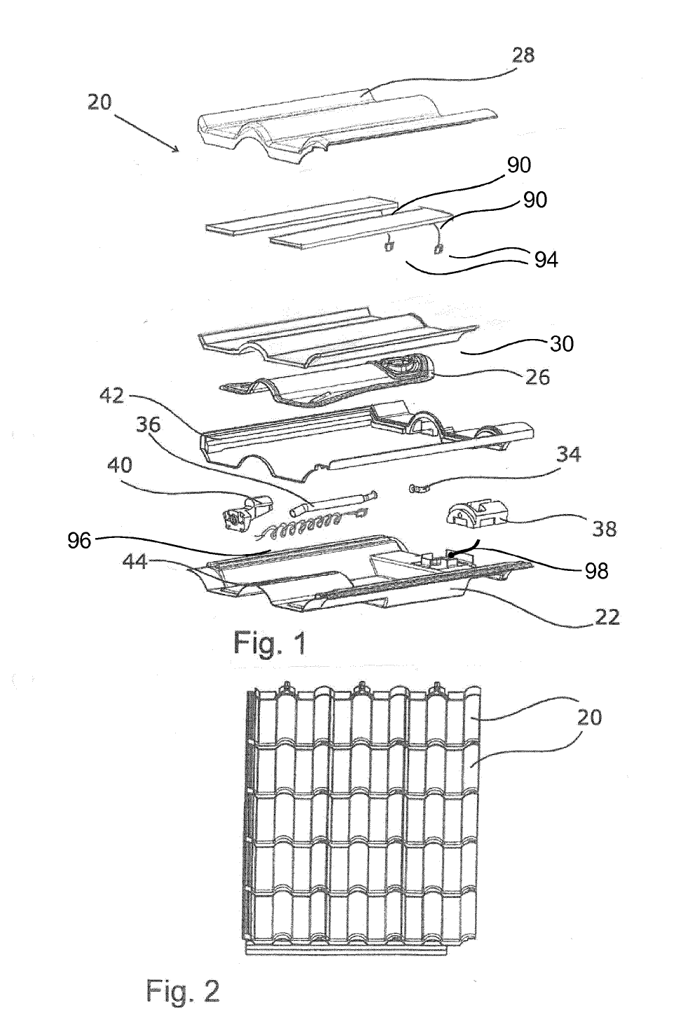

FIG. 1 shows a top view of the solar energy roof tile according to the invention;

FIG. 2 shows a portion of a roof, which is covered with solar energy roof tiles according to the invention;

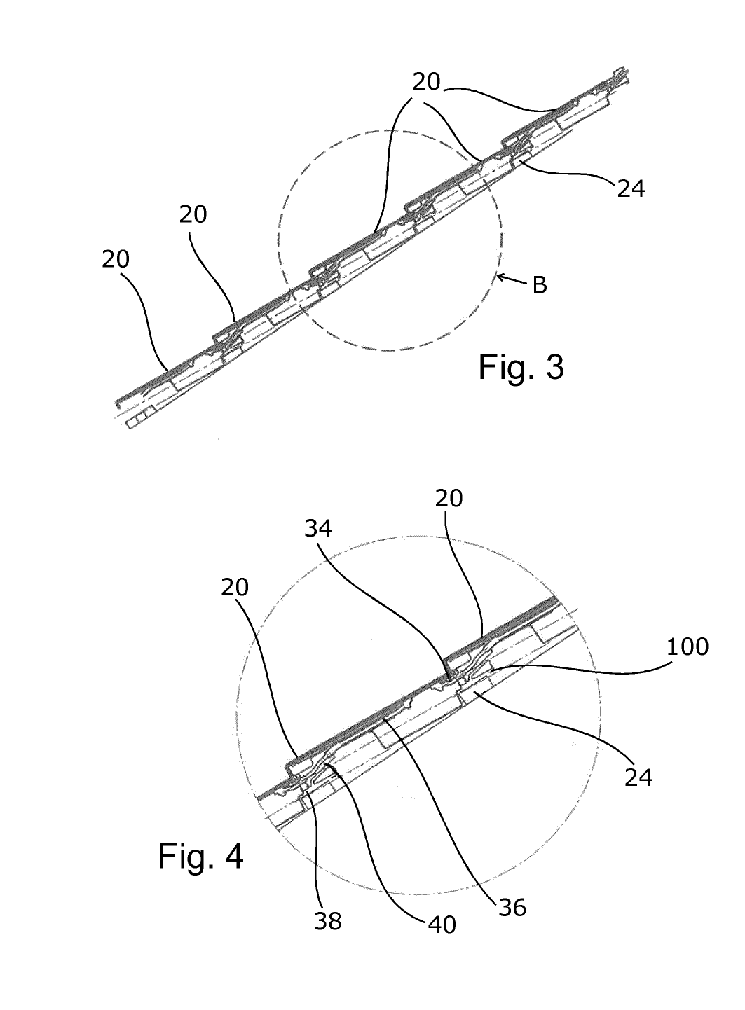

FIG. 3 shows a row of assembled solar energy roof tiles in cross section;

FIG. 4 shows a sectional enlargement of FIG. 3;

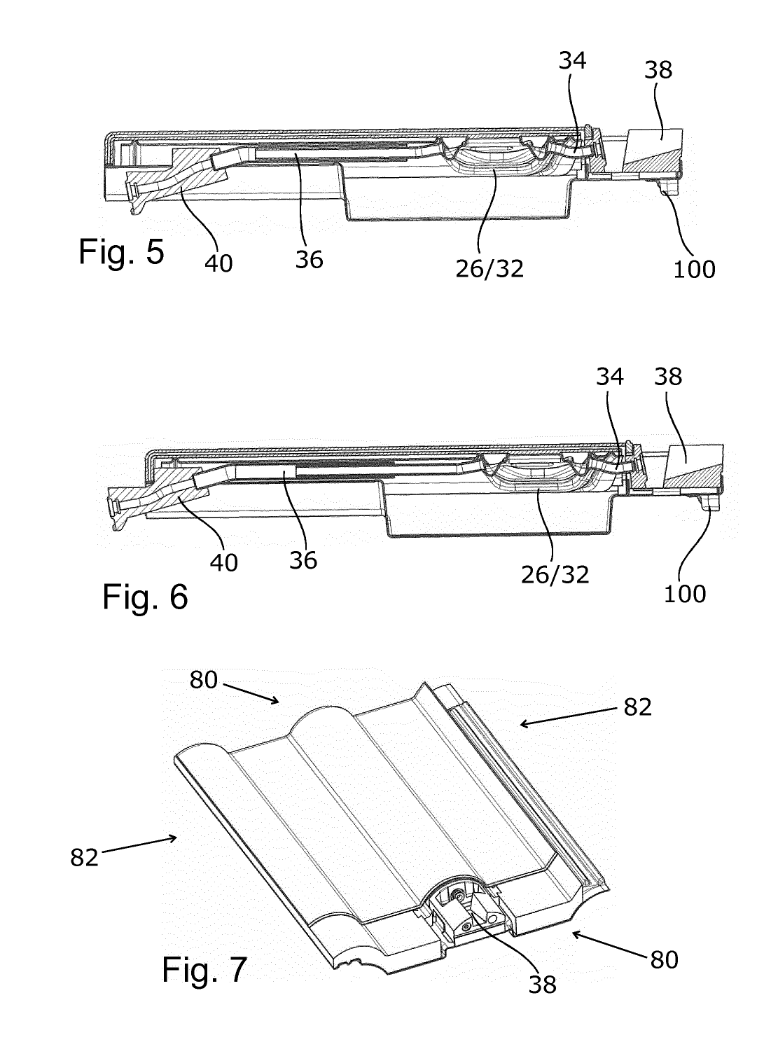

FIG. 5 shows a water-bearing unit of the solar energy roof tile in longitudinal section;

FIG. 6 shows a longitudinal section of the solar energy roof tile according to the invention, with the connection element being extended;

FIG. 7 shows a top view of a solar energy roof tile according to invention;

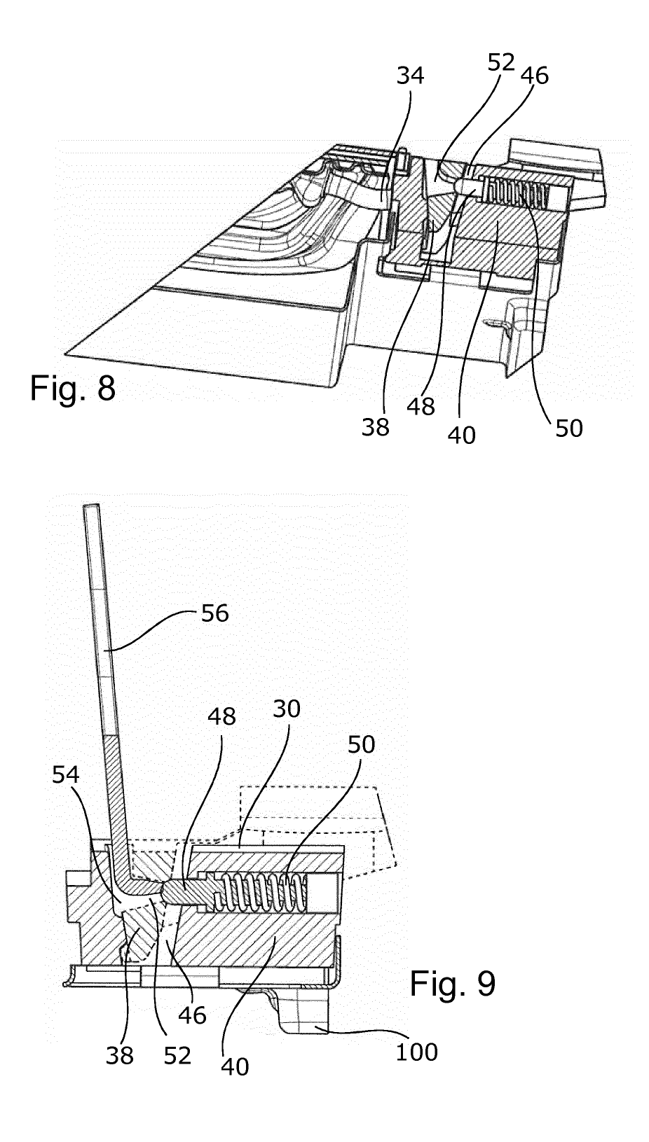

FIG. 8: shows two connecting elements of two solar energy roof tiles in the assembled state;

FIG. 9 shows a releasing operation of the connection of FIG. 8 with the help of a tool;

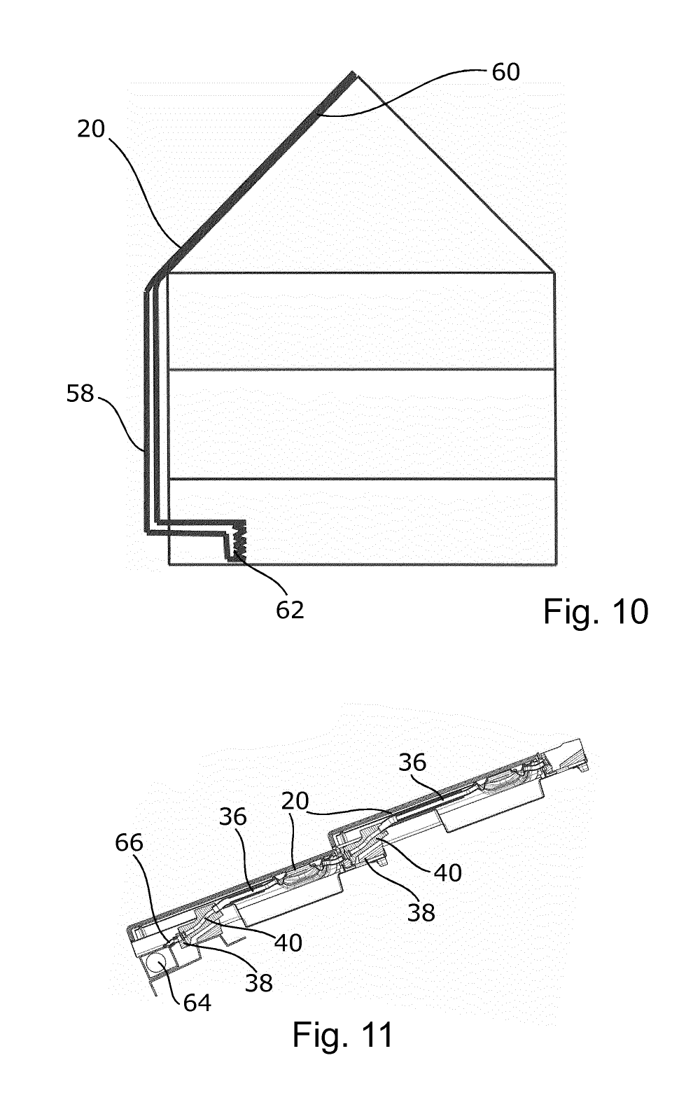

FIG. 10 shows a strongly simplified representation of a system for obtaining thermal and electrical energy according to the invention;

FIG. 11 shows coupling of solar energy roof tiles to a feeder line;

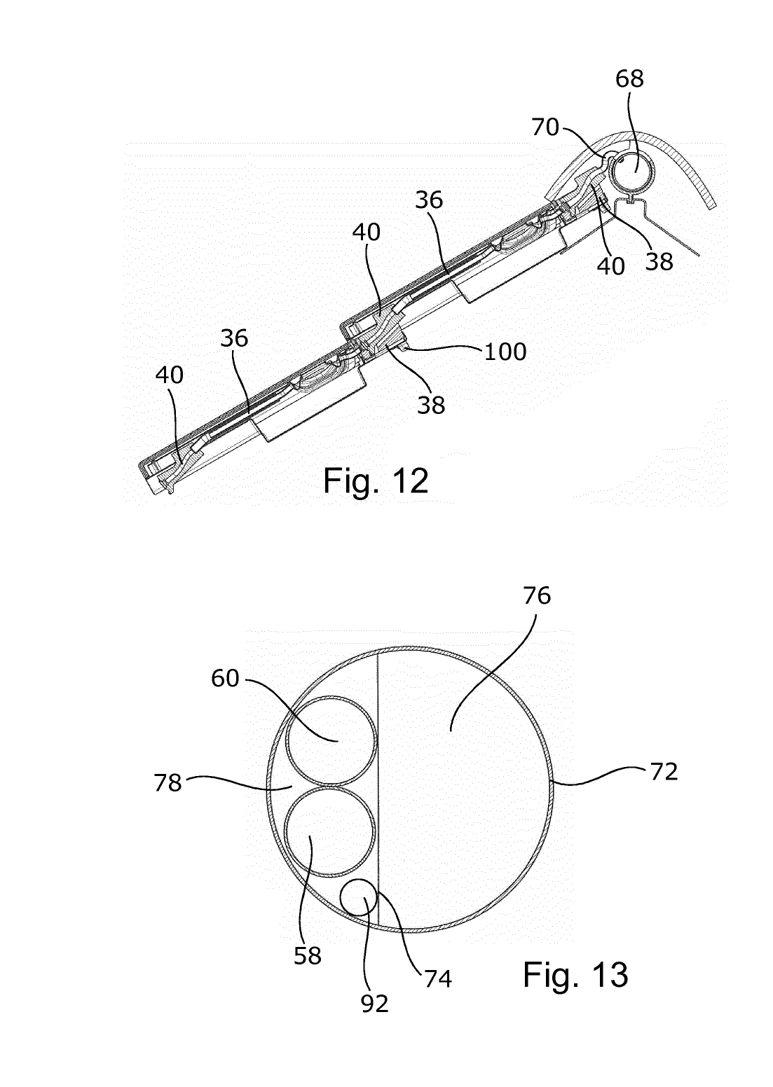

FIG. 12 shows coupling of the solar energy roof tiles to a manifold;

FIG. 13 shows a cross section of a downspout including connecting lines;

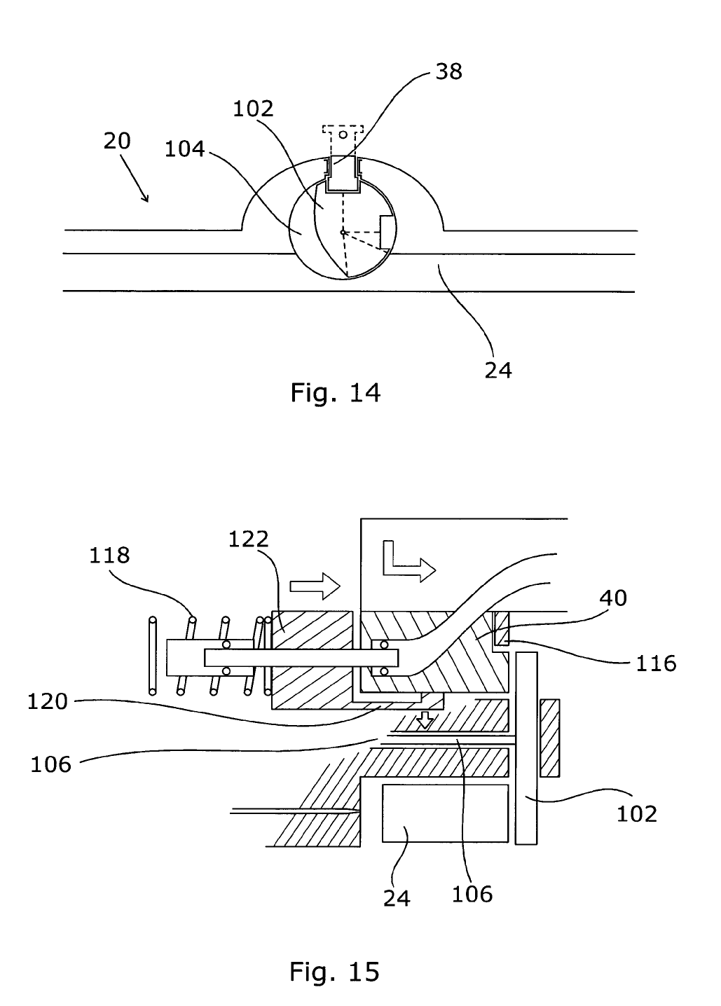

FIG. 14 shows an alternative connection means by a rotary slide in a schematic diagram;

FIG. 15 shows the alternative connection means of FIG. 14 with additional sledge;

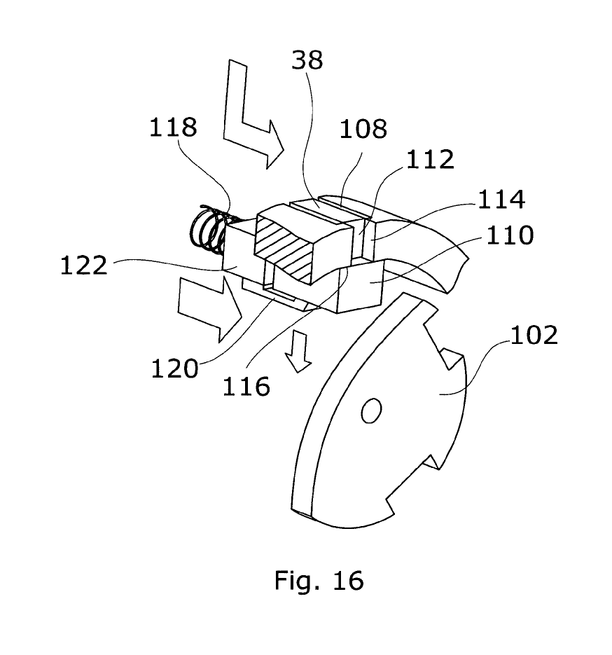

FIG. 16 shows a perspective representation of the sledge.

FIG. 1 shows an explosive representation of a preferred embodiment of a solar energy roof tile 20 according to the invention. Basically, the solar energy roof tile 20 is configured in sandwich-type construction mode. Starting from of a base tile 22, which forms a bottom side of a solar energy roof tile 20 and is laid on top of a roof supporting structure 24 (also cf. FIG. 3), it is followed by an absorber 26 and preferably a transparent or translucent cover 28. It is to be seen that the absorber 26 is formed of an upper absorber element 30 and a lower absorber element 32. In the exemplary embodiment shown, two photovoltaic modules 90 are arranged adjacent to each other between the cover 28 and the upper absorber element 30. The photovoltaic modules 90 abut on the upper absorber element 30 to assure optimal heat transfer. The photovoltaic modules 90 and the upper absorber element 30 are preferably adhered to each other with a heat conductive adhesive.

A combined element is also conceivable, which forms the upper absorber element 30 and the photovoltaic module 90 together, preferably adjacent to each other. The cover 28 approximately has the same shape as the upper absorber element 30, thus entirely covering said absorber element. The lower absorber element 32 will be passed-through by a fluid not shown. It is therefore coupled to an inlet line 34 and an outlet line 36. The inlet line 34 is followed by a first connecting element 38 and the outlet line is followed by a second connecting element 40. The two connecting elements 38, 40 each may be connected to a corresponding connecting element 38, 40 of an adjacent solar energy roof tile 20.

A frame 42 is furthermore shown, approximately having the dimensions of the base tile 22 and serving for the accommodation of the absorber 26. Moreover, in the working example shown, the cover 28 is supported on the frame 42 and is connected thereto.

The second connecting element 40 is guided in a longitudinal groove 44 of the base tile 22. This significantly facilitates assembly of the solar energy roof tile 20 by way of specifically pulling out the second connecting element 40. The longitudinal groove 44 furthermore avoids distortion of the second connecting element 40.

Finally, it is essential for the outlet line 36, which is arranged between the lower absorber element 32 and the second connection element 40 to be changeable in length. In the working example shown, it is formed as a trumpet pipe, which is formed of two pipe portions which are slidable into each other and having different diameters. The photovoltaic modules 90 comprise electrical cable connections 94. Moreover, a first power line 96 is shown, which helically extends around the outlet lines 36 30 of the absorber 26 and is connected with the second connecting element 40. A second power line 98 is connected to the first connecting element 38. The first power line 96, the second power line 98 and the cable connections 94 are connected to each other, preferably via a plug-in element not shown, such that several solar energy roof tiles 20 are interconnected in a parallel ascending manner. In an especially advantageous embodiment variant, which is not shown herein, the first power line 96 is arranged within the outlet line 36. It may also extend in the interior of the outlet line 36, but the outlet line 36 may also comprise a cavity, preferably a longitudinal channel in its wall, in which longitudinal channel the first power line 96 extends. This has the advantage, that the power line 96 cannot come in contact with the fluid. In the embodiment variant shown, the two connecting elements 38, 40 each have an electrical contact surface, which in turn is electrically conductive connected to the associated power line 96, 98, wherein the contact surfaces, in the assembled state of two connecting elements 38, 40, contact each other, thus causing the electrical connection.

From the FIGS. 2 to 4, the installation according to the invention of solar energy roof tiles 20 on a roof or a roof supporting structure 24, respectively, becomes clear. FIG. 2 shows a top view of a region of a roof FIG. 3 shows a longitudinal section across a row of solar thermal roof tiles 20, and FIG. 4 shows an enlarged view of the region B from FIG. 3.

It is to be seen that the solar energy roof tiles 20 which are connected to each other, overlap in some areas, similar to conventional roofing with conventional roof tiles. They abut against the roof supporting structure 24 with their bottom side, i.e. the bottom side of the base tile 22. Especially in FIG. 4 it is shown that respective adjacent solar energy roof tiles 20 arranged one over the other, and are connected to each other via the connecting elements 38, 40. Thus flow-through fluid is passed from a solar energy roof tile 20 through the inlet line 34, the two connecting elements 38, 40, the absorber 26 and the outlet lines 36, or electrical power is passed through the cable connections 94, the two power lines 96,98 and the photovoltaic module 90 to the next solar energy roof tile 20, respectively.

As it is especially shown in FIG. 4, the solar energy roof tiles 20 are mounted via the retaining collars 100 into the roof supporting structure 24, the especially roof battens. The retaining collars engage behind the roof supporting structure 24. FIG. 5 illustrates the design of the solar energy roof tile 20 according to the invention. It is to be seen that the first connecting element 38 is followed by the inlet line 34 and leading to the lower absorber element 32. After the fluid flows through the lower absorber element 32 and has appropriately been heated it is passed to the second connecting element 40 through the outlet line 36.

For installation of the solar thermal roof tiles 20 it is furthermore of advantage, that the absorber 26, especially the upper absorber element 30 as well as the cover 28, do not entirely cover the first connection element 38 so that it easily remains accessible during tiling the roof. The first connection element 38 will finally be first covered by the installed adjacent solar energy roof tile 20, thereby being no longer visible in the installed state.

FIG. 6 shows a longitudinal section of a solar energy roof tile 20 having extended second connection element 40. The outlet line 36, which, in the working example shown, is formed as a trumpet pipe, is changeable in length, so that the second connection element 40 may be pulled out beyond the overall dimensions of the solar energy roof tile 20. It then protrudes opposite of the respective edge or side of the solar energy roof tile 20 and may smoothly be connected to an adjacent first connection element 38.

FIG. 7 explains, by way of a top view representation of the solar energy roof tile 20, that in the initial state, there are no elements protruding over the overall dimensions of the solar energy roof tile 20. The overall dimensions are specified by the two transverse sides 80 and the two longitudinal sides 82. It may as well be seen that an accommodation opening 46 of the first connecting element 38, in the initial state, is not covered by the absorber 26 or the cover 28, but is open towards the top, i.e. towards the direction facing away from the base tile 22. The accommodation opening 46 essentially is formed as being T-shaped.

The FIGS. 8 and 9 exemplify the advantageous connection of two solar energy roof tiles 20 via the two connecting elements 38, 40. The two connecting elements 38, 40 are shown in longitudinal section view, wherein the outlet line 36 is not being drawn. What may be seen is the accommodation opening 46 (or accommodating recess), into which the second connecting element 40 is insertable. The T-shape causes the connection to be secured in essentially horizontal direction, i.e. in the extension direction of the second connecting element 40, and the two connecting elements 38, 40 may not be disengaged from each other.

In addition, spring-loaded pins 48 are to be seen as snap-in elements. In the working example shown, two pins 48 are provided, each one of which being oriented parallel adjacent to the outlet line 36.

A spring element 50 urges the respective pin 48 towards an accommodation 52, which is arranged in the second connecting element 40. A snap-in or click connection will thereby result, which also secures essentially in the vertical direction, i.e. transversally to the extension direction of the second connecting element 40. The pins 48 each have a conically shaped free end, the diameter of which is dimensioned such that the pins 48 will not be entirely inserted into the respective accommodation 52. In this way, it will be achieved that the spring force of the spring element 50 acts towards an appropriate edge of the respective accommodation 52, thus urging the second connecting element 40 against an opposite opening of the inlet line 34. The openings of the outlet line 36 and the inlet line 34 therein abut against each other. The pressure of the spring element 50 causes a tight connection between the two connecting elements 38, 40 and the electrical connection between the contact surfaces to be assured.

In the exemplary embodiment, an edge of the accommodation 52 and the outer surface of the pins 48 serve as contact surfaces for the electrical connection of the two connecting elements 38, 40.

FIG. 9 furthermore shows that, in the assembled state of the two connecting elements 38, 40, an access opening 54 for a tool 56 results. Into this access opening 54, an angular-shaped tool 56 is insertable, by which tool the two pins 48 may be pushed back against the spring force of the spring element 50, thus allowing release of the two connecting elements 38, 40 from each other.

From FIG. 10 it will be seen how a system is to be designed, which makes use of the solar energy roof tile according to the invention 20. Relatively cold fluid is supplied to the solar energy roof tiles 20 via a cold-water line 58. Said fluid will be heated when flowing through the solar energy roof tiles 20 connected to each other and will be recycled via a hot water line 60 back to the heat exchanger 62, or alternatively will be recycled back to direct utilization. The two connecting lines, i.e. the cold-water line 58 and the hot water line 60, couple the solar energy roof tiles 20 to the utilization facility, for example a water supply system of house. A main power line 92 extends parallel to the cold-water line 58 and the hot water line 60 (cf. FIG. 13). The main power line 92 may sectionally be arranged in the region of a gutter board of the roof.

FIG. 11 illustrates the conveyance of the relatively cold fluid via a feeding line 64 to the solar energy roof tiles 20. The feeding line 64 preferably is arranged in the region of a gutter board of the roof. A row of solar energy roof tiles 20, which are arranged in the edge region of an area of solar energy roof tiles 20 according to the invention, preferably the lower row of a roof, is coupled to feeding line 64 via a supply feeding line 66. The supply feeding line 66 connects the feeding line 64 to each of the first connection element 38 of a solar energy roof tile 20.

FIG. 12 shows attachment of the solar energy roof tiles 20 of the uppermost row to a collecting line 68. A collecting supply line 70 extends from the second connection element 38 into the collecting line 68, feeding heated fluid thereto.

FIG. 13 illustrates an advantageous installation of the connecting lines, i.e. the cold-water line 58 and the hot water line 60 as well as the main power line 92, in some places within a downspout 72. In this case, the downspout 72 preferably is divided into two compartments by a separating wall 74, wherein a first compartment 76 is for discharging rain water, a second compartment 78 is for accommodating the two connecting lines 58, 60 and the main power line 92. This mode of installation, on the one hand, is cost-effective and quickly feasible, on the other hand the external appearance of the house will not negatively be effected.

The FIGS. 14 and 15 show an alternative mode of connecting by means of a rotary slide 102 in a schematic diagram. The rotary slide 102 replaces the retaining collars 100 and, accordingly, is arranged approximately in that region. The solar energy roof tiles according to invention 20 are engaged into the roof supporting structure 24 via the rotary slide 102.

The rotary slide 102 has a free space 104, via which the roof supporting structure 24 may be released as it is, so that the solar energy roof tile 20 is displaceable in an axial direction. For pulling out or inserting the solar energy roof tile 20, the rotary slide 102 is required to be turned into the appropriate position, so that it no longer engages behind the roof supporting structure 24. For this, the rotary slide 102 comprises a rotational axis 106 (cf. FIG. 15).

The rotary slide 102 simultaneously is the abutment for the second connecting element 40, which otherwise could be further displaced into the axial direction. This especially arises from FIG. 16. The second connecting element 40 is guided in an accommodation 108 and has a step design, with a lower base body 110 and an upper base body 112, wherein the lower base body 110 in transversal direction to the longitudinal axis of the solar energy roof tile 20 is formed broader than the upper base body 112.

The accommodation 108 comprises a through opening 114, through which the upper base body 112 may axially be passed due to its lower width, whereas the lower base body 110 may not be passed through. Moreover, an undercut 116 is provided in the range of the through opening 114, against which the lower base body 110 abuts from the bottom, and thus may not be guided out of the accommodation 108 and to the top.

FIG. 16 shows another advantageous embodiment variant, where adjacent to the rotary slide 102, a sledge 122 is additionally provided, which facilitates and secures the connection. The sledge 122 is spring-loaded and biased at its base position via a compression spring 118. A lever 120 maintains the sledge 116 in its biased position by contacting an abutment. If the second connecting element 40 is inserted into the first connecting element 38 from the top, the lever 120 is pushed downwards and becomes disengaged from the abutment, thus releasing the spring force. The sledge 116 moves towards the rotary slide 102 to contact it. Meanwhile, it is located below the two undercuts 116 with its lower base body 110. Thus, the second connecting element 40 is maintained both in the axial direction by the rotary slide 102, and in the vertical direction by the undercut 116. Advancing the sledge 122 also causes a line portion 126, which is part of the inlet line 34, to be pushed into the outlet line 36 of the second connecting element 40. Moreover, electrical contacts are closed to transfer the electrical energy (not shown).

Furthermore, FIG. 15 shows a lock bolt 124, via which the solar energy roof tile 20 is attachable to the roof supporting structure 24, for example as a wind suction protection.

The invention is not limited to the working examples shown and represented, but also includes other possible embodiments. Especially, instead of the outlet line 36, the inlet line 34 or even both lines 34, 36 may be formed as being changeable in length. Instead of the base tile 22, it is also conceivable that the absorber 26 is for mounting directly to the roof structure 24, i.e. the base tile 22 may thus be omitted.

1. A solar energy roof tile (20) for the production of electrical and thermal energy from solar radiation, the shape of which essentially corresponds to the shape of a conventional roof tile, having a base tile (22), for mounting the solar energy roof tile (20) on a roof and furthermore comprising a photovoltaic module (90) arranged on top, which is connected to a first power line (96) and a second n power line 98), and an absorber (26) with an inlet line (34) and an outlet line (36) passed-through by a medium, wherein the inlet line (34), at its free end, comprises a first connecting element (38), the outlet line (36), at its free end, comprises a second connecting element (40), at least one of which lines (34, 36) are designed as being changeable in length in a base state, both connecting elements (38, 40) are arranged within the outer dimensions of the solar energy roof tile (20), in an assembly state, at least one of the two connecting elements (38, 40) is expandable beyond the outer dimensions of the solar energy roof tile (20) and is connectable to a corresponding connecting element (38, 40) of an adjacent solar energy roof tile (20) while being in medium communication and electrically conductive, the length-variable line (34, 36) comprises one of the two power lines (96. 98).

2. The solar energy roof tile (20) according to claim 1, characterized in that the first power line (96) extends along the outlet line (38).

3. The solar energy roof tile (20) according to claim 1, characterized in that the first power line (96) is integrated into the outlet line (38).

4. The solar energy roof tile (20) according to claim 2, characterized in that the two connecting elements (38, 40) each comprises an electrical contact surface, which contact surface is connected in an electrically conductive manner via an associated power line (96, 98) to the photovoltaic module (90), wherein the contact surfaces, in the assembled state of two connecting elements (38, 40), contact each other, thus causing electrical connection to be provided.

5. The solar energy roof tile (20) according to claim 1, characterized in that the outlet line (34) is configured as being changeable in length and the first connecting element (38) and the inlet line (34) are fixedly arranged within of the solar energy roof tile (20).

6. The solar energy roof tile (20) according to claim 1, characterized in that the two connecting elements (38, 40) are formed such that they form a snap-in connection.

7. The solar energy roof tile (20) according to claim 1, characterized in that the first connecting element (38) comprises an accommodation opening (46) being open towards the top and t-shaped in horizontal plane for accommodating the second connecting element (40) which is also formed as being T-shaped.

8. The solar energy roof tile (20) according to claim 7, characterized in that the second connecting element (40) comprises at least one accommodation (52), into which a snap-in element is engageable, the snap-in element being arranged in the first connecting element (38).

9. The solar energy roof tile (20) according to claim 8, characterized in that the snap-in element is configured as a spring-loaded pin (48), wherein the accommodation (52) and the pin (48) are arranged essentially in horizontal direction.

10. The solar energy roof tile (20) according to claim 9, characterized in that the accommodation (52) and the snap-in element are formed of an electrically conductive material, at least in certain area, and forming the electrical conductive contact surfaces.

11. The solar energy roof tile (20) according to claim 10, characterized in that the free end of the pin (48) is conically configured such that said pin contacts an edge limiting the accommodation (52).

12. The solar thermal roof tile (20) according to claim 9, characterized in that the two connecting elements (38, 40), in the assembled state of the two connecting elements (38, 40), form an access opening (54) foe a tool (56), by means of which the pin (48) may be urged backwards, allowing release of the two connecting elements (38, 40) from each other.

13. A solar thermal system for the production of thermal energy from solar radiation, comprising solar energy roof tiles (20) according to claim 1 connected to each other, which are coupled to a utilization facility via a cold-water line (58) and a hot water line (60) and a main power line (92).

14. The solar system according to claim 13, characterized in that solar energy roof tiles (20), in the edge region of a surface of solar energy roof tiles (20) according to the invention, are attached to a respective feeder line (64) via a feeder supply line (66), the feeder line being connected to the cold water line (58), in that solar energy roof tiles (20), in the opposite edge region of the surface, are attached to a respective manifold (68) via a manifold supply line (70), the manifold being connected to the hot water line (60).

15. The solar system according to claim 13, characterized in that the cold water line (58), the hot water line (60) and the main power line (92) are partially arranged in a downspout (72).
